(19) United States
(12) Patent Application Publication
(10) Pub. No.: US 2015/0007720 A1
(43) Pub. Date: Jan. 8, 2015

(54) COALESCING MEDIA CLEANING SYSTEM AND METHOD

(71) Applicant: BHA Altair, LLC, Franklin, TN (US)

(72) Inventors: Huong Van Vu, Duluth, GA (US); Michael Adelbert Sullivan, Woodstock, GA (US); Avnit Singh, Marietta, GA (US); Eric Milton Lafontaine, Atlanta, GA (US)

(73) Assignee: BHA Altair, LLC, Franklin, TN (US)

(21) Appl. No.: 13/934,360

(22) Filed: Jul. 3, 2013

(51) Int. Cl. B01D 46/00; B01D 46/42

(52) U.S. Cl. CPC B01D 46/0075; B01D 46/4227
USPC 95/20; 55/422; 96/398; 95/278; 95/1

(57) ABSTRACT

A filter assembly and method of operating the filter assembly includes a hinge attached to a first end of a filter while a lifting mechanism is attached to a second end of the filter. The lifting mechanism lifts and releases the second end of the filter causing an impact such that dust and debris caught in the filter is dislodged.

### BACKGROUND OF THE INVENTION

The subject matter disclosed herein relates to maintenance of air treatment systems containing moisture coalescing media that remove moisture from intake air.

Gas turbines include inlet air treatment systems that remove moisture and dust from air that is channeled to the compressor of the gas turbine. Some air treatment systems include moisture separators, or coalescing panels, that remove moisture from intake air and particle filters that remove dust and debris from the intake air. During normal operating conditions, it is desired to have the air treatment system channel the dry, filtered air to the compressor with minimal airflow disruption and air pressure drop. Eventually, used coalescers become clogged, thereby generating a decrease in air pressure under normal operating conditions. Over time, the pressure drop across the coalescers reduces the operating efficiency of the gas turbine. In some instances, the reduced air pressure may cause a compressor surge that may damage the compressor. Coalescers typically have to be removed manually to be cleaned or replaced. This removal process is labor intensive, time consuming, and may require shutdown of the gas turbine.

The discussion above is merely provided for general background information and is not intended to be used as an aid in determining the scope of the claimed subject matter.

### BRIEF DESCRIPTION OF THE INVENTION

A filter assembly and method of operating the filter assembly includes a hinge attached to a first end of the filter assembly while a lifting mechanism is attached to a second end of the filter assembly. The lifting mechanism lifts and releases the second end of the filter assembly causing an impact such that dust and debris caught in the filter assembly is dislodged and falls away. An advantage that may be realized in the practice of some disclosed embodiments of the filter assembly is automatic cleaning of coalescing filters used in air treatment systems while operating the air treatment system substantially continuously, especially in high dust and high fog regions. This reduces the differential pressure across the coalescing media and thereby improves gas turbine output and reduces maintenance costs.

In one embodiment, a filter assembly is disclosed for use with a filter hood having an inlet opening. The inlet opening has a first end and a second end. The filter assembly includes a filter unit having a first end and a second end, and a hinge attaching the first end of the filter unit to the first end of the inlet opening. A lifting mechanism is attached to the second end of the filter unit proximate to the second end of the inlet opening. The lifting mechanism is configured to lift the second end of the filter unit from a filtering position that obstructs the inlet opening to a bypass position that does not obstruct the inlet opening. The lifting mechanism is configured to release the second end of the filter unit such that it falls from the bypass position back into the filtering position.

In another embodiment, a filter house includes a plurality of filter units having air passing therethrough. A lifting mechanism is connected to the plurality of filter units and comprises means for lifting the plurality of filter units and for dropping the plurality of lifted filter units to dislodge material from the filter units that accumulates therein by the air passing therethrough.

In another embodiment, a method of cleaning a filter includes electronically receiving a command signal to activate a cleaning cycle. In response to the command signal, at least one end of the filter is lifted followed by releasing the at least one lifted end of the filter to cause an impact for dislodging debris from the filter.

This brief description of the invention is intended only to provide a brief overview of subject matter disclosed herein according to one or more illustrative embodiments, and does not serve as a guide to interpreting the claims or to define or limit the scope of the invention, which is defined only by the appended claims. This brief description is provided to introduce an illustrative selection of concepts in a simplified form that are further described below in the detailed description. This brief description is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

So that the manner in which the features of the invention can be understood, a detailed description of the invention may be had by reference to certain embodiments, some of which are illustrated in the accompanying drawings. It is to be noted, however, that the drawings illustrate only certain embodiments of this invention and are therefore not to be considered limiting of its scope, for the scope of the invention encompasses other equally effective embodiments. The drawings are not necessarily to scale, emphasis generally being placed upon illustrating the features of certain embodiments of the invention. In the drawings, like numerals are used to indicate like parts throughout the various views. Thus, for further understanding of the invention, reference can be made to the following detailed description, read in connection with the drawings in which:

FIG. 1 is a diagram of an exemplary air treatment system;

FIG. 2 is a cutaway perspective view of an exemplary coalescer cleaning system;

FIG. 3 is a diagram of an exemplary cam/coalescer assembly in a first position;

FIG. 4 is a diagram of the exemplary cam/coalescer assembly of FIG. 3 in operation;

FIG. 5 is a diagram of the exemplary cam/coalescer assembly of FIG. 3 in a second position;

FIG. 6 is a cutaway perspective view of another exemplary coalescer cleaning system; and

FIG. 7 is a flowchart of a method of operating the exemplary coalescer cleaning systems shown in FIGS. 1-6.

### DETAILED DESCRIPTION OF THE INVENTION

The exemplary methods and systems described herein overcome the disadvantages of known air treatment systems by providing an automatic coalescer maintenance system that cleans used coalescers without requiring manual intervention, or shutdown time. More specifically, the embodiments described herein facilitate removal of accumulated dust and other debris from coalescers during operating periods when the pressure drop through the used coalescers is high enough, as detected by a differential pressure sensor, or they may be automatically activated at normally scheduled periodic intervals. In addition, the embodiments described herein facilitate automatically cleaning the used coalescers without requiring a human operator for manual cleaning

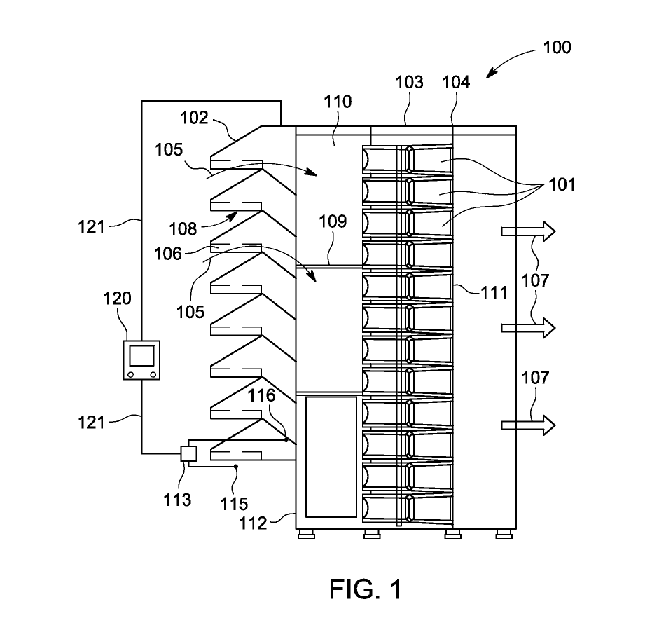

FIG. 1 is a diagram of an exemplary inlet air treatment system 100 that includes multiple intake hoods 102, interior air space 110, filters 101, tube sheet 104, and filter house 103 that receives intake airflow 105 and removes moisture and dust therefrom. Inlet air treatment system 100 then directs the filtered exit airflow 107 through downstream ducts. During operation, inlet air treatment system 100 may channel the filtered exit airflow 107 to a gas turbine, such as described above.

The operation of inlet air treatment system 100 may be monitored by several sensors that detect various conditions inside and outside of the inlet air treatment system 100. For example, electronic or mechanical pressure sensors 113 may monitor ambient air pressure outside of the intake hoods 102 at an outside sensing point 115 and static pressure levels within intake hoods 102 at an inside sensing point 116, thereby determining a differential pressure magnitude across a coalescer 106 by calculating a difference between these two measured pressures. The differential pressure may increase due to decreased intake airflow 115 through the coalescer 106 which may be caused by dust, dirt, moisture, or other debris clogging air passages in the coalescer 106. The air passages may also be blocked with ice forming therein during low temperature operation. The pressure sensors 113 may be positioned at one or more of the intake hoods 102 at a first side of coalescers 106 to monitor air pressure of intake air 105 prior to entering coalescers 106 and at a second side of coalescers 106 after exiting coalescers 106 as just described. Pressure sensors 113 may monitor other locations in an air stream within inlet air treatment system 100.

Air treatment system 100 includes intake hoods 102 that are coupled in flow communication with the filter house 103, such that an intake airflow 105 is defined between an assembly of intake hoods 102 and air filters 101. Intake hoods 102 are vertically-spaced and mounted to a front wall 112 of filter house 103. In an exemplary embodiment, each intake hood 102 includes a hood opening 108 allowing the intake airflow 105 to enter filter house 103, a coalescer 106 (or coalescing panel), and a coalescer cleaning assembly, as will be described below. Each coalescer 106 is positioned within hood opening 108 to facilitate moisture removal from intake airflow 105 channeled through hood opening 108 into filter house 103. Intake airflow 105 is channeled through intake hood 102 through opening 108, and then toward air filters 101 via internal channel 110. Internal channel 110 is a space between intake hoods 102 and air filters 101, and includes walkways 109 for maintenance staff to manually access the coalescers 106. The use of coalescers 106 for removing moisture from intake airflow 105 is well known. Typical coalescers 106 include at least two interoperative layers, namely, a first layer comprising a moisture separator and, on top of that, a coalescing pad. The layered structures of the coalescers 106 are illustrated herein as a unitary structure for simplicity since the layered structure is not essential to the embodiments described herein.

In one embodiment, filter house 103 includes a tube sheet 104 upon which cartridge-type filter elements 101 are mounted. In the exemplary embodiment, a plurality of access walkways 109 extend between the matrix of filter elements 101 and the intake hoods 102 to provide access to each intake hood 102 and the coalescers 106. The plurality of filters 101 are each coupled to tube sheet 104 such that each filter 101 extends circumferentially about a corresponding opening 111 in the tube sheet 104 to provide an exit path for exiting airflow 107. In one exemplary embodiment, filters 101 are in flow communication with ambient air entering the inlet air treatment system 100 via the intake hoods 102 and the cleaned exit airflow 107 to the right of filter system 100, as seen in FIG. 1. Similar to pulse filters (cylindrical filters) explained above, static rectangular filters can also be used which are clamped or bolted to a frame instead of to the tube sheet 104.

During operation of inlet air treatment system 100, intake hoods 102 channel intake airflow 105 toward air filters 101. As intake airflow 105 enters intake hoods 102 through coalescers 106, the coalescers 106 act to remove moisture from the intake airflow 105. Airflow 105 travels through internal channel 110 through filters 101 which remove dust and debris carried by airflow 105. Exit airflow 107 is then channeled to a downstream gas turbine, for example. The gas turbine provides sufficient suction for forcing the intake airflow 105 to be drawn into inlet air treatment system 100 through intake hoods 102, the coalescers 106, and through the air filters 101.

In one embodiment, a control system 120 may be implemented in hardware and software communicates with differential pressure sensor 113 via wired or wireless communication links 121. In one embodiment, the communication links 121 comprise electric circuits remotely communicating data and command signals between the differential pressure sensor 113 and the control system 120 in accordance with any wired or wireless communication protocol known to one of ordinary skill in the art guided by the teachings herein. Such data signals may include electric signals indicative of differential pressure magnitudes detected by differential pressure sensor 113 transmitted to the control system 120 and, in response thereto, various command signals communicated by the control system 120 to inlet air treatment system 100, such as described below.

The control system 120 may be a computer system of sufficient complexity to receive data signals from pressure sensor 113 indicating a magnitude of measured differential air pressure and to perform diagnostics on those parameters such as determining whether the measured differential air pressure is within a preset threshold stored in an electronic memory coupled to the control system 120. In addition to differential pressure sensor 113, moisture sensors may also be connected to control system 120 to sense moisture levels or fog and to communicate such measurements to the control system 120. A sufficient hardware embodiment may include a controller, a microcontroller, a microcomputer, a programmable logic controller (PLC), a field programmable gate array (FPGA), an application specific integrated circuit, and other programmable circuits. It should be understood that a processor and/or control system 120 can also include memory, input channels, and output channels. The control system 120 executes stored programs to control the operation of the inlet air treatment system 100 based on data signals received from pressure sensors 113 and on stored settings input by human operators. Programs executed by the control system 120 may include, for example, calibrating algorithms for calibrating pressure sensors 113. User input may be provided by a display which includes a user input selection device. In one embodiment the display may be responsive to user contact or the control system 120 may contain a keyboard or keypad which operates in a conventional well known manner. Thus, the user can input desired operational functions, numerical ranges, and thresholds available with the control system 120. Commands may be generated by the control system in response to parameter magnitudes received as data signals from pressure sensors 113 to activate various operations implemented by the inlet air treatment system 100 as described herein, including activating the cleaning assemblies and systems as described below. Operations performed by assemblies within filter house 103 in response to an air pressure differential exceeding a preset maximum, as detected and reported by pressure sensors 113, include automatic cleaning of the coalescers 106. As mentioned above, increased differential air pressure is typically caused by blocked air passages in the coalescer 106 due to clogging by dirt, debris, or ice formation. The control system 120 can be used together with existing differential air pressure monitoring systems by receiving the output differential air pressure measurement signals therefrom.

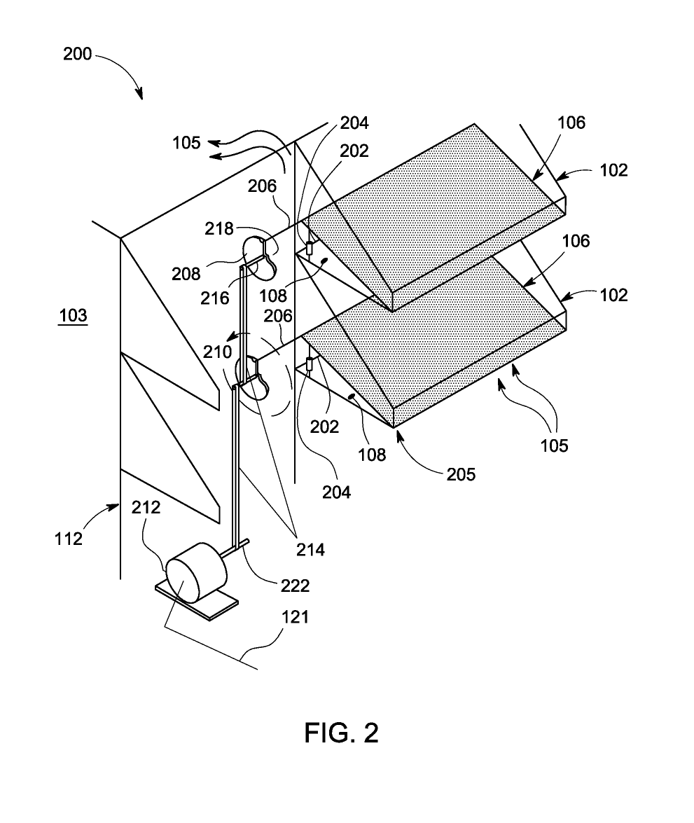

FIG. 2 is a cutaway view of an exemplary coalescer cleaning assembly 200 disposed within an intake hood 102, that may be used for cleaning coalescers 106 in one or more of the intake hoods 102 of the air treatment system 100. In an exemplary embodiment, inlet air treatment system 100 includes a plurality of intake hoods 102 coupled to an outer wall 112 of the filter house 103. Each intake hood 102 also includes a frame bracket member 202 for supporting a coalescer 106 at its rearward end in position across hood opening 108 while the coalescer 106 removes moisture from the intake airflow 105 passing therethrough. A plurality of coalescers 106 are disposed within intake hoods 102 of air treatment system 100 such that a major surface of each coalescer 106 substantially covers the hood opening 108 when the coalescer 106 is lowered into a filtering position. The coalescer 106 may be manufactured to include a perimeter frame that fits onto the frame bracket member 202 for suspending the rearward end of the coalescer 106 substantially across the entirety of the hood opening 108 when they are placed in the filtering position. In the assembly as shown in FIG. 2, coalescers 106 are raised, or lifted, into a bypass position by the cams 208 wherein an air flow 105 may bypass the coalescers 106. The coalescers 106 may be disposed in the filtering position when released by the cams 208 to substantially cover the hood openings 108 when they are dropped into the filtering position, such that an airflow 105 enters through a major bottom surface of coalescers 106. De-moisturized intake airflow 105 exits coalescers 106 through a major top surface of coalescers 106 and into the filter house 103.

The automated cleaning assembly includes an electric motor 212, such as a servo motor, which is in electrical communication with the control system 120 over communication line 121, and is mechanically connected to the coalescers 106. The coalescers 106 each include an extension rod 206 that extends from a rearward end of the coalescers 106 such that when the extension rod 206 is lifted the rearward end of the corresponding coalescer 106 is also lifted. The forward end 205 of the coalescers 106 may each be attached to a forward portion of an intake hood 102 by a pin or other suitable hinge mechanism that allows the forward end 205 to rotate about an axis coextensive with the pin, or hinge, while the rearward end of the coalescer 106 is lifted by its extension rod 206.

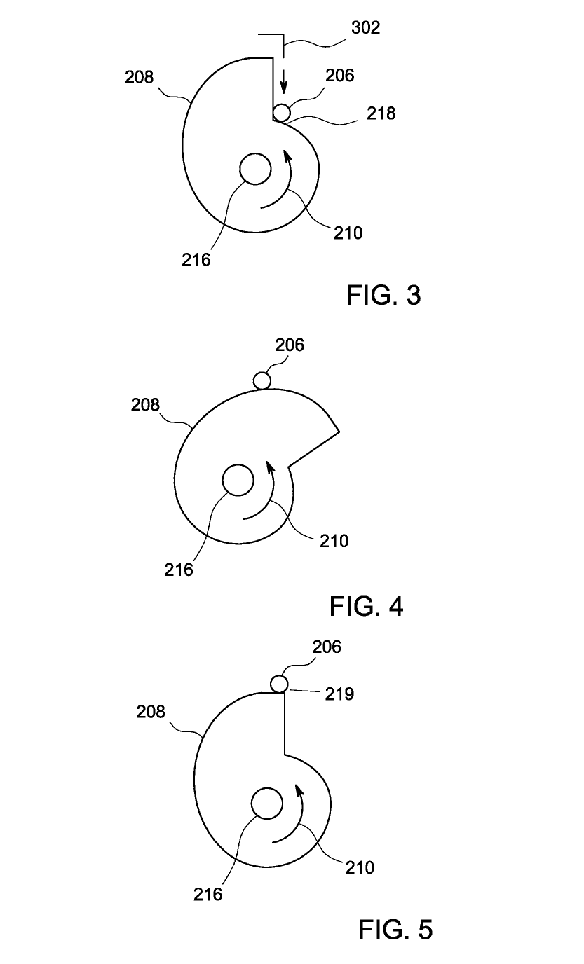

With reference to FIGS. 2-5, the extension rod 206 of each coalescer 106 rests on a perimeter of a cam 208, also known as a snail drop cam. The end of the extension rod 206 that is in contact with the cam 208 may comprise a low friction surface, a roller, or a combination thereof. When the coalescer 106 is in a first position, which is a filtering position, the coalescer 106 blocks the opening 108 of the intake hood 102 and filters the air passing into the filter house 103. In this first position, i.e., the normal operating mode of the filter house 103, the extension rod 206 rests on the low point 218 of the cam 208, as illustrated in FIG. 3. Upon detecting a differential pressure drop transmitted by differential pressure sensor 113 that exceeds a preset threshold, the control system 120 may issue a command over communication line 121 to the motor control 212 to begin a cleaning cycle. The motor 212, in response to the command signal, will rotate one or more cams 208 in a counter-clockwise direction 210. Each cam 208 supports an extension rod 206 and, thereby, a coalescer 106. As the cam 208 rotates, the extension rod 206 is lifted by the perimeter of the cam 208, as shown in FIG. 4. Eventually, the extension rod 206 is lifted to a peak of the cam 208 at position 219, the second position which may be referred to herein as a bypass position, as shown in FIG. 5 and, when this peak 219 is passed during rotation of the cam 208, the extension rod 206, and the rearward end of the coalescer 106, drops by force of gravity to position 218 as indicated by the arrow 302 shown in FIG. 3. This rapid drop causes the extension rod 206 and the rearward end of the coalescer 106 to impact the frame bracket member 202 with sufficient force to loosen the dirt and debris clogging the bottom side of the coalescer 106, which dirt and debris may then fall to the ground or into a waste bin. The impact of the coalescer 106 dropping against the frame bracket member 202 may be enhanced by attaching a spring 204 to an edge of the coalescer 106 and to a bottom edge of the intake hood 102. Thus, when the coalescer 106 is released by the cam 208 from the peak position 219 the speed at which it drops is increased by the tension of the spring 204 pulling it downward. The electric motor 212 may continue rotating one or more of the cams 208 for a programmed preset number of rotations, under control of control system 120, to repeatedly raise and drop the coalescers 106 to insure that the dirt and other debris are dislodged from at least the bottom face of the coalescers 106. If the sensor 113 indicates that the differential pressure across a coalescer 106 is still excessive after a cleaning cycle, the cleaning cycle may be repeated by control system 120 as necessary.

The electric motor 212 includes a drive shaft 222 that is rotated when the motor 212 is activated by control system 120. In one embodiment, drive belts 214 are disposed about electric motor 212 drive shaft 222 and are driven by the rotating drive shaft 222 by friction. The drive belts 214 may be similarly disposed about the camshaft 216 for rotating at least one cam 208. The drive shaft 222 may have one or more drive belts 214 disposed thereon with each connected to a corresponding cam shaft 216 and cam 208. Alternatively, additional drive belts 214 may be connected between two or more neighboring camshafts 216, and cams 208, for driving the two or more cams 208 by one drive belt 214 coupled to electric motor 212. In other embodiments, a drive chain may be used, or individual actuators for each bank of coalescers 106, instead of, or in combination with, drive belts 214. When activated by control system 120, the motor 212 can rotate multiple cams 208 for raising and dropping multiple coalescers 106 one or more times during a cleaning cycle. In addition to relying upon differential pressure sensors 113 for detecting an excessive pressure drop across coalescers 106, thereby activating a cleaning cycle for the coalescers 106 as described above, the control station 120 may be programmed to initiate cleaning cycles according to preset periodic time intervals, time of day clocks, or other time scheduling features.

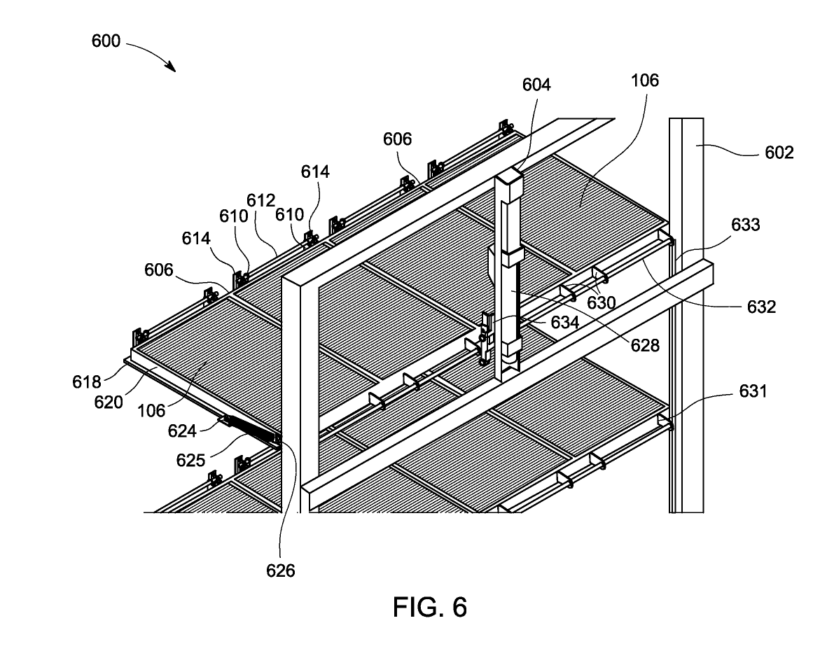

FIG. 6 is a cutaway view of an exemplary coalescer 106 cleaning assembly 600 disposed within an intake hood 102 of an air treatment system 100 that may be used for cleaning coalescers 106. In an exemplary embodiment, coalescer cleaning assembly 600 may be coupled to an outer wall 112 of the filter house 103, which outer wall 112 may include a frame structure 602, or may have such a frame structure 602 added to the wall 112 for attaching the coalescer cleaning assembly 600 thereto. FIG. 6 does not illustrate the top portion of the intake hoods 102 or the walls, e.g. 112, of the filter house 103 for purposes of clarity in the Figure. Coalescer cleaning assembly 600 comprises coalescers 106 secured in position by a coalescer frame 620 which, in turn, is supported by a lip 618 of the intake hood 102. The coalescers 106 are further held in place within the coalescer frame 620 by cross-members 606 attached to front and back portions of the coalescer frame 620.

At the forward end of the coalescers 106, frame brackets 614 are each attached to an inside surface of the hood 112 and to a support rod 612 such that the support rod 612 may rotate within the frame brackets 614. Corresponding to each of the frame brackets 614 is a coalescer bracket 610 that is attached to the coalescer frame 620 and to the support rod 612 such that the support rod 612 may rotate within the coalescer brackets 610. Thus, the front portion of the coalescer frame 620, and the coalescers 106, are able to rotate about the support rod 612, wherein the support rod 612 thereby acts as a hinge, when a rearward side of the coalescer frame 620 is lifted, as will be explained below.

The rearward side of the coalescer frame 620 includes frame bracket members 630 attached to coalescer frame 620 and to the support rod 632. Also at the rearward side of the coalescers 106 is an air cylinder support 604 that is attached to the frame structure 602. A pneumatically driven air cylinder 628 is capable of moving vertically within the air cylinder support 604 under gas pressure provided thereto by an air hose (not shown) which is electronically controlled via commands issued from control station 120 to cause the air cylinder to rise and/or fall within the air cylinder support 604. Thus, signals from the control system 120 control the pressurized air hose feeding air pressure to the air cylinder 628. The air cylinder 628 is attached to a cylinder bracket 634 which, in turn, is rotatably attached to the support rod 632. Thus, when pneumatic pressure is applied to the air cylinder 628 it rises and lifts the rearward side of the coalescer frame 620 together with the coalescers 106 secured therein. In one embodiment, the air cylinder 628 is a single action air cylinder which rises under pneumatic pressure provided thereto, for example, by an air hose, and falls back down when the pressure is released. The air cylinder may include an enclosed gas pressure chamber having a shaft disposed therein which is extended by the increased pneumatic pressure provided to the gas chamber. By this action of the air cylinder 628, the attached coalescer frame 620, and the coalescers 106 secured therein, are lifted and are allowed to fall back down against the lip 618 of the intake hood 102 with an impact sufficient to dislodge dirt and debris accumulated in the coalescers 106 as described above with respect to the embodiment of FIGS. 2-5. To enhance the impact of the coalescer frame 620 and the coalescers 106 therein against the lip 618 of the intake hood 102, a spring 625 may be attached to a portion of the coalescer frame 620 at spring attachment point 626, and to the lip 618 of the intake hood 620 at another spring attachment point 624. When the air cylinder 628 lifts the rearward side of the coalescer frame 620, and the coalescers 106 therein, the spring 625 is brought into tension and will forcibly pull the coalescer frame 620 downward to cause a greater impact against the lip 618 of the intake hood 102. Thus, when the coalescer 106 is released from its lifted position by the air cylinder 628 the speed at which it drops is increased by the tension of the spring 625 pulling it downward.

Two of the rearward side frame brackets 630 closest to a vertical portion of the frame structure 602, one rearward side frame bracket 630 at each end of the coalescer frame 620, are each attached to a corresponding vertical support rod 633 which, in turn, is connected to one or more rearwards side frame brackets 631 that are attached to additional similarly constructed coalescer assemblies 600 supported by the frame structure 602. Thus, one air cylinder 628 may be mechanically coupled to a plurality of coalescer assemblies 600 for simultaneously lifting and releasing the plurality of coalescer assemblies 600.

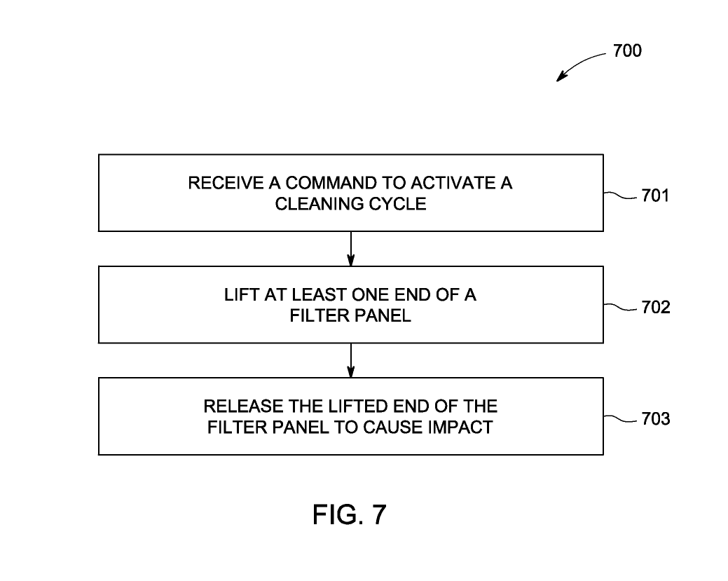

FIG. 7 illustrates a flow chart that depicts a method 700 of operating an air treatment system 100, such as disclosed herein. At step 701, an electronic command signal is received for activating a cleaning cycle. This may entail receiving the command signal over the communication line 121 connected to a motor control for motor 212 which activates the motor 212 to rotate a drive shaft 222 a preset number of times, which drive shaft is mechanically coupled to coalescers 106, as described above. This may alternatively entail receiving the command signal from communication line 121 at an electronically controllable supply of pressurized air for activating the air cylinder 628, which is mechanically coupled to coalescers 106, as described above. In either case, the motor 212, or the air cylinder 628, is activated to lift at least one end of a connected coalescer 106 (i.e., filter panel) at step 702. At step 703, the lifted end of the coalescer 106 is released such that the lifted end of the coalescer 106 drops or falls, either due to gravity or under added mechanical acceleration provided by an attached spring mechanism, as described above. After being released, the coalescer 106 impacts a component of the air treatment system 100, such as a lip of the intake hood 618 or a frame bracket member 202. The impact is sufficient to cause debris, dust, and other contaminants trapped by the coalescer 106 to be dislodged from the coalescer 106.

In view of the foregoing, embodiments of the invention automatically maintain and clean filter elements without requiring labor intensive manual intervention. A technical effect is to reduce the differential pressure across the coalescing media and thereby improve gas turbine output.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.), or an embodiment combining software and hardware aspects that may all generally be referred to herein as a “service,” “circuit,” “circuitry,” “module,” and/or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Program code and/or executable instructions embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer (device), partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A filter assembly for a filter hood having an inlet opening, wherein the inlet opening has a first end and a second end, the filter assembly comprising:
a filter unit having a first end and a second end;
a hinge attaching the first end of the filter unit to the first end of the inlet opening of the filter hood;
a lifting mechanism attached to the second end of the filter unit proximate to the second end of the inlet opening of the filter hood; and
wherein the lifting mechanism is configured to lift the second end of the filter unit from a filtering position obstructing the inlet opening to a bypass position not obstructing the inlet opening and is configured for releasing the second end of the filter unit such that it falls from the bypass position back into the filtering position.

2. The filter assembly of claim 1, wherein the lifting mechanism comprises a cam mechanism having a rotatable cam driven by a motor, and wherein the rotatable cam is coupled to the second end of filter unit for said lifting the second end of the filter unit.

3. The filter assembly of claim 2, wherein the filter unit comprises a rod extending therefrom coupled to the rotatable cam, and wherein the rotatable cam comprises a cam shaft coupled to the motor via at least one belt, or at least one chain, or a combination thereof.

4. The filter assembly of claim 3, further comprising a second filter unit having a second rod extending therefrom coupled to a second rotatable cam, and wherein the second rotatable cam comprises a second cam shaft coupled to the motor via the at least one belt, the at least one chain, or a combination thereof.

5. The filter assembly of claim 1, wherein the lifting mechanism comprises an air cylinder connected to the second end of the filter unit, the air cylinder activated by pressurized gas for pneumatically lifting the second end of the filter unit from the filtering position to the bypass position and for releasing the filter unit to fall back into the filtering position.

6. The filter assembly of claim 5, further comprising a second filter unit connected to the air cylinder for lifting the second filter unit from the filtering position to the bypass position.

7. The filter assembly of claim 1, further comprising:
a differential pressure sensor for measuring a differential pressure across the filter unit; and
a controller in electrical communication with the differential pressure sensor and with the lifting mechanism, wherein the controller is configured to receive a differential pressure measurement signal from the differential pressure sensor and to determine whether the sensed differential pressure exceeds a preset threshold and, if so, to send a command signal to the lifting mechanism for lifting and releasing the second end of the filter unit.

8. The filter assembly of claim 1 wherein the filter unit comprises a coalescing panel.

9. The filter assembly of claim 1, further comprising a spring mechanism attached to the filter unit for increasing a speed at which the second end of the filter unit falls from the bypass position back into the filtering position.

10. A filter house comprising:
a plurality of filter units having air passing therethrough;
a lifting mechanism connected to the plurality of filter units; and
wherein the lifting mechanism comprises means for lifting the plurality of filter units and for dropping the plurality of lifted filter units to dislodge material from the filter units that is accumulated therein by the air passing therethrough.

11. The filter house of claim 10, wherein the lifting mechanism comprises one or more rotatable cams, the one or more rotatable cams driven by a motor, wherein the one or more cams are each coupled to one end of at least one filter unit for said lifting the plurality of filter units.

12. The filter house of claim 11, wherein the plurality of filter units each comprise a rod extending therefrom that is coupled to a corresponding rotatable cam, and wherein the one or more rotatable cams each comprise a cam shaft coupled to the motor via at least one belt, at least one chain, or a combination thereof.

13. The filter house of claim 10, wherein the lifting mechanism comprises an air cylinder coupled to the plurality of filter units, the air cylinder receiving pressurized gas for pneumatically lifting the plurality of filter units and for releasing the plurality of filter units to dislodge material from the filter units that is accumulated therein by the air passing therethrough.

14. The filter house of claim 13, wherein the plurality of filter units are connected to a support, and wherein the support is connected to the air cylinder for said pneumatically lifting the plurality of filter units.

15. The filter house of claim 10, further comprising:
one or more differential pressure sensors for measuring a differential pressure across the plurality of filter units; and
a controller in electrical communication with the one or more differential pressure sensors and with the lifting mechanism, wherein the controller receives one or more differential pressure measurement signals and determines whether any of the received pressure measurement signals exceeds a preset threshold and, if so, sends a command signal to the lifting mechanism for lifting and releasing the plurality of filter units.

16. The filter house of claim 10, wherein the filter unit comprises a coalescing panel.

17. The filter house of claim 10, further comprising a plurality of springs each attached to a corresponding filter unit for increasing a dropping speed when dropping the plurality of lifted filter units to dislodge the material from the filter units.

18. A method of cleaning a filter, the method comprising:
electronically receiving a command signal to activate a cleaning cycle;
in response to the command signal, lifting at least one end of the filter; and
releasing the at least one lifted end of the filter to cause an impact for dislodging debris from the filter.

19. The method of claim 18, further comprising electronically transmitting the command signal in response to electronically detecting a differential pressure across the filter that exceeds a preset threshold or in response to electronically detecting an expiration of a preset time interval.

20. The method of claim 18, wherein the step of lifting the at least one end of the filter comprises activating an air cylinder, a rotatable cam, or a combination thereof.
